(19) United States
(12) Patent Application Publication
(10) Pub. No.: US 2013/0138378 A1
(43) Pub. Date: May 30, 2013

(54) COMPUTING DEVICE AND METHOD FOR COMPENSATING FOR PERPENDICULAR ERRORS OF THREE-COORDINATE MEASURING MACHINES

(71) Applicants: CHIH-KUANG CHANG, Tu-Cheng (TW); HUA-WEI YANG, Shenzhen City (CN); MIN-JUN HUANG, Shenzhen City (CN)

(72) Inventors: CHIH-KUANG CHANG, Tu-Cheng (TW); HUA-WEI YANG, Shenzhen City (CN); MIN-JUN HUANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/488,681

(22) Filed: Jun. 5, 2012

(30) Foreign Application Priority Data
Nov. 30, 2011 (CN) 201110389677.5

(51) Int. Cl. G06F 19/00; G01B 5/008

(52) U.S. Cl. 702/95

(57) ABSTRACT

In a computing device and method for compensating for perpendicularity errors of a three-coordinate measuring machine, coordinates of touched points on an X-axis, a Y-axis, and a Z-axis of the three-coordinate measuring machine are acquired and respectively recorded into an X array, a Y array, and a Z array. A perpendicular error Axy of the X-axis and the Y-axis, a perpendicular error Axz of the X-axis and the Z-axis, and a perpendicular error Ayz of the Y-axis and the Z-axis using the X array, the Y array, and the Z array are computed using the X array, the Y array, and the Z array. The perpendicular errors Axy, Axz and Ayz then stored into a compensation record for later use.

### BACKGROUND

1. Technical Field

Embodiments of the present disclosure relate to error compensation techniques, and particularly to a computing device and a method for compensating for perpendicular errors of three-coordinate measuring machines.

2. Description of Related Art

A three-coordinate measuring machine is a device for measuring the physical dimensions of an object in three dimensions (three-dimensional (3D) device). This measuring machine may be manually controlled by an operator or it may be computer controlled. Measurements are made by a probe attached to third axes of this measuring machine.

The three axes of the measuring machine include an X-axis, a Y-axis, and a Z-axis. For a variety of reasons, the X-axis, the Y-axis, and the Z-axis may be not be perfectly perpendicular. Thus, measurements made by the measuring machine may be not accurate.

### BRIEF DESCRIPTION OF THE DRAWINGS

FIG. 1 is a block diagram of one embodiment of a computing device.

FIG. 2 is a schematic diagram of a three-coordinate measuring machine.

FIG. 3 illustrates a flowchart of one embodiment of a method for compensating for perpendicular errors of a three-coordinate measuring machine.

FIG. 4 is a schematic diagram of the computation of perpendicular errors in relation to a three-coordinate measuring machine.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

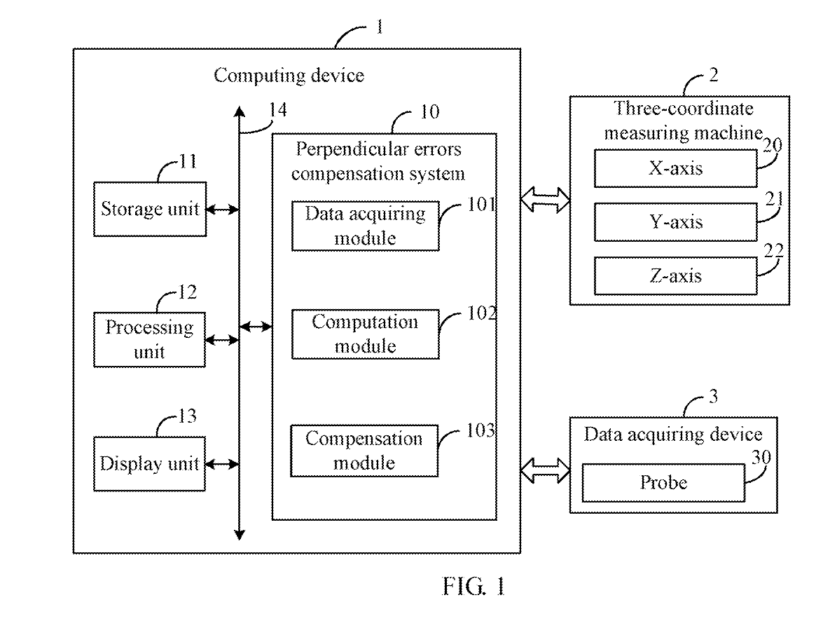

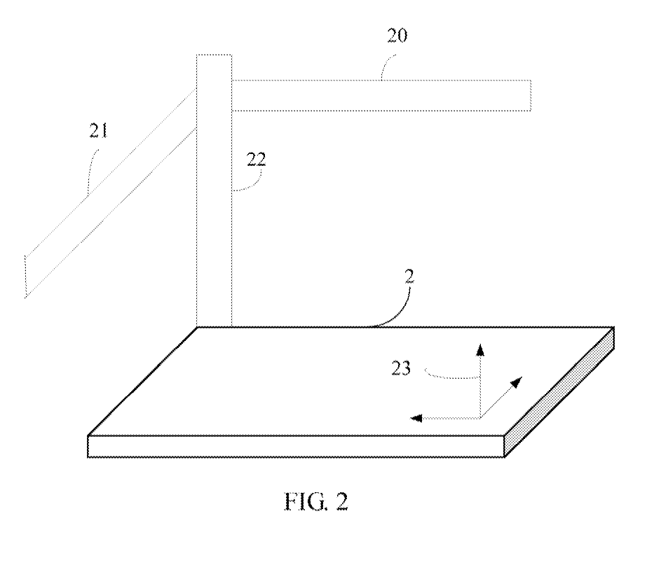

FIG. 1 is a block diagram of one embodiment of a computing device 1 for compensating for perpendicular errors of the three axes of a three-coordinate measuring machine (hereinafter “measuring machine 2”). The three axes of the measuring machine 2 includes an X-axis 20, a Y-axis 21, and a Z-axis 22. As illustrated in FIG. 2, the X-axis 20, the Y-axis 21, and the Z-axis 22 are physical components perpendicularly installed on the measuring machine 2.

The computing device 1 may be a computer, a server, or a personal digital assistant (PDA), or the like. The computing device 1 includes a perpendicular error compensation system 10. The computing device 1 may further include components such as a storage unit 11, a processing unit 12, a display unit 13, and a bus 14. The computing device 1 may be configured in a number of other ways and may include other or different components.

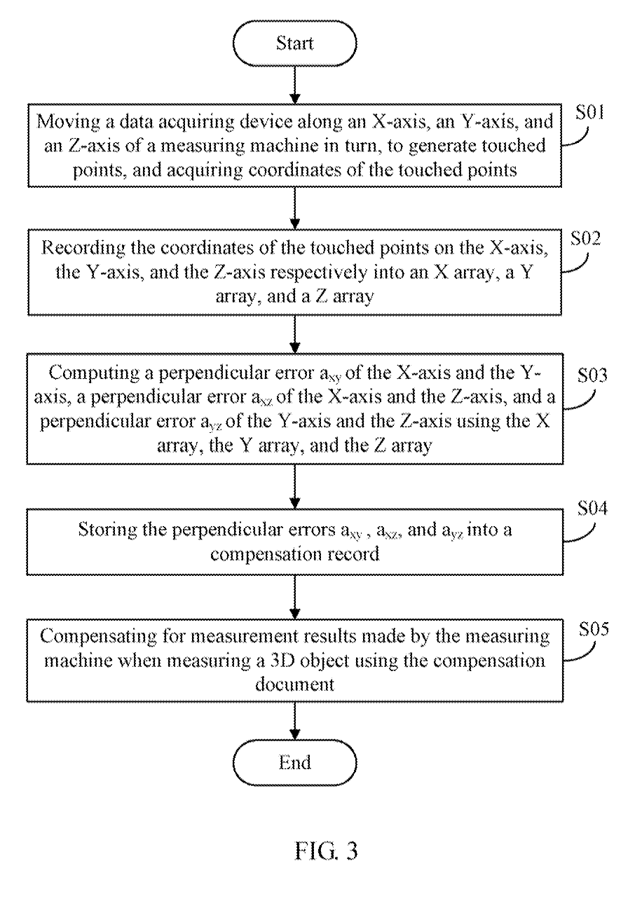

The perpendicular error compensation system 10 includes a number of function modules, such as a data acquiring module 101, a computation module 102, and a compensation module 103. The function modules 101-103 may include computerized code in the form of one or more programs, and provide at least the functions needed to execute the steps illustrated in following FIG. 3.

The storage unit 11 may include some type(s) of non-transitory computer-readable storage medium, such as a hard disk drive, a compact disc, a digital video disc, or a tape drive. The storage unit 11 stores the computerized code of the function modules 101 to 103 of the perpendicular error compensation system 10. The storage unit 11 also stores data needed or generated by the perpendicular error compensation system 10.

The processing unit 12 may include a processor, a microprocessor, an application-specific integrated circuit (ASIC), and a field-programmable gate array, (FPGA) for example. The processing unit 12 may execute the computerized code of the function modules 101 to 103 of the perpendicular error compensation system 10 to realize the functions of the perpendicular error compensation system 10 illustrated as follows.

The display unit 13 may include one or more output mechanisms, including a display or a printer, for example.

The bus 14 permits intercommunication among the components, such as the measuring program management system 10, the storage unit 11, the processing unit 12, and the display unit 13.

The computing device 1 communicates with a data acquiring device 3, for controlling the data acquiring device 3 to move on the X-axis 20, the Y-axis 21, and the Z-axis 22 in turn, enable a probe 30 of the data acquiring device 3 makes contacts with the X-axis 20, the Y-axis 21, and the Z-axis 22 during movement of the data acquiring device 3 to generate a plurality of touched points. For example, during moving on the X-axis 20, the probe 30 is controlled to make contact with the X-axis 20 at the beginning of the movement to generate the first touched point. After touching, the probe 30 is controlled to lift up to not contact with the X-axis 20. The probe 30 is controlled to make contact with the X-axis 20 again after the probe 30 has moved a predetermined distance, such as 10 millimeters, to generate the second touched point. After touching, the probe 30 is controlled to lift up again, and the like.

FIG. 3 illustrates a flowchart of one embodiment of a method for compensating for perpendicular errors of a three-coordinate measuring machine. Depending on the embodiment, additional steps may be added, others removed, and the ordering of the steps may be changed.

In step S01, the data acquiring module 101 controls the data acquiring device 3 to move on the X-axis 20, the Y-axis 21, and the Z-axis 22 of the measuring machine 2 in turn, to generate touched points on the X-axis 20, the Y-axis 21, and the Z-axis 22, and acquire coordinates of the touched points in a coordinate system 23 of the measuring machine 2. In detail, the data acquiring module 101 may, for example, firstly control the data acquiring device 3 to move on the X-axis 20, then, control the data acquiring device 3 to move on the Y-axis 21, and finally, control the data acquiring device 3 to move on the Z-axis 22 of the measuring machine 2. In other embodiments, the data acquiring module 101 may firstly control the data acquiring device 3 to move on the Z-axis 22, then, control the data acquiring device 3 to move on the X-axis 20, and finally, control the data acquiring device 3 to move on the Y-axis 21 of the measuring machine 2 or apply any other sequence of movements.

In step S02, the data acquiring module 101 records the coordinates of the touched points on the X-axis 20, the Y-axis 21, and the Z-axis 22 respectively into an X array, a Y array, and a Z array. In detail, the data acquiring module 101 records the coordinates of the touched points generated when the data acquiring device 3 is made to move on the X-axis 20 into the X array, records the coordinates of the touched points generated when the data acquiring device 3 is made to move on the Y-axis 21 into the Y array, and records the coordinates of the touched points generated when the data acquiring device 3 is made to move on the Z-axis 20 into the Z array. The X array may include {(X₁₁, Y₁₁, Z₁₁), (X₁₂, Y₁₂, Z₁₂), (X₁₃, Y₁₃, Z₁₃) . . . (X₁ₙ, Y₁ₙ, Z₁ₙ)}, the Y array may include {(X₂₁, Y₂₁, Z₂₁), (X₂₂, Y₂₂, Z₂₂), (X₂₃, Y₂₃, Z₂₃) . . . (X₂ₙ, Y₂ₙ, Z₂ₙ)}, and the Z array may include {(X₃₁, Y₃₁, Z₃₁), (X₃₂, Y₃₂, Z₃₂), (X₃₃, Y₃₃, Z₃₃) . . . (X₃ₙ, Y₃ₙ, Z₃ₙ)} for example. It may be understood that, if the X-axis 20, the Y-axis 21, and the Z-axis 22 are perfectly perpendicular, the coordinates in the X array may be {(X₁₁, Y₁₁, Z₁₁), (X₁₂, Y₁₁, Z₁₁), (X₁₃, Y₁₁, Z₁₁) . . . (X₁ₙ, Y₁₁, Z₁₁)}. However, because the X-axis 20, the Y-axis 21, and the Z-axis 22 are not exactly perpendicular, when X-coordinates of points on the X-axis change, the Y-coordinates and the Z-coordinates of the points also changed.

In step S03, the computation module 102 computes a perpendicular error Axy of the X-axis 20 and the Y-axis 21, a perpendicular error Axz of the X-axis 20 and the Z-axis 22, and a perpendicular error Ayz of the Y-axis 21 and the Z-axis 22 using the coordinates in the X array, the Y array, and the Z array.

In one embodiment, the computation module 102 computes a mean coordinates ( X̅₁, Y̅₁, Z̅₁) of the coordinates in the X array, a mean coordinates ( X̅₂, Y̅₂, Z̅₂) of coordinates in the Y array, and a mean coordinates ( X̅₃, Y̅₃, Z̅₃) of the coordinates in the Z array. For example, in the mean coordinates ( X̅₁, Y̅₁, Z̅₁),

$$\overline{{X}_{1}} = \frac{{X}_{11} + {X}_{12} + {X}_{13} + … + {X}_{1 n}}{n} , \\ \overline{{Y}_{1}} = \frac{{Y}_{11} + {Y}_{12} + {Y}_{13} + … + {Y}_{1 n}}{n} , \\ and$$

$$\overline{{Z}_{1}} = \frac{{Z}_{11} + {Z}_{12} + {Z}_{13} + … + {Z}_{1 n}}{n} .$$

After the mean coordinates have been computed, the computation module 102 constructs a line Lx using an origin O which has the coordinates (0, 0, 0) and a first point which has the coordinates ( X̅₁, Y̅₁, Z̅₁), constructs a line Ly using the origin O and a second point which has the coordinates ( X̅₂, Y̅₂, Z̅₂), and constructs a line Lz using the origin O and a third point which has the coordinates ( X̅₃, Y̅₃, Z̅₃).

After the lines Lx, Ly, and Lz have been constructed, the computation module 102 computes an angle βxy between the line Lx and the line Ly an angle βxz between the line Lx and the line Lz, and an angle βyz between the line Ly and the line Lz. In one embodiment, cos βxy=Lx²+Ly²−Lxy²/2LxLy, where

Lx=\sqrt{(X1−0)²+(Y1−0)²+(Z1−0)}²,

Ly=\sqrt{(X2−0)²+(Y2−0)²+(Z2−0)}², and

Lxy=\sqrt{(X1−X2)²+(Y1−Y2)²+(Z1−Z2)}².

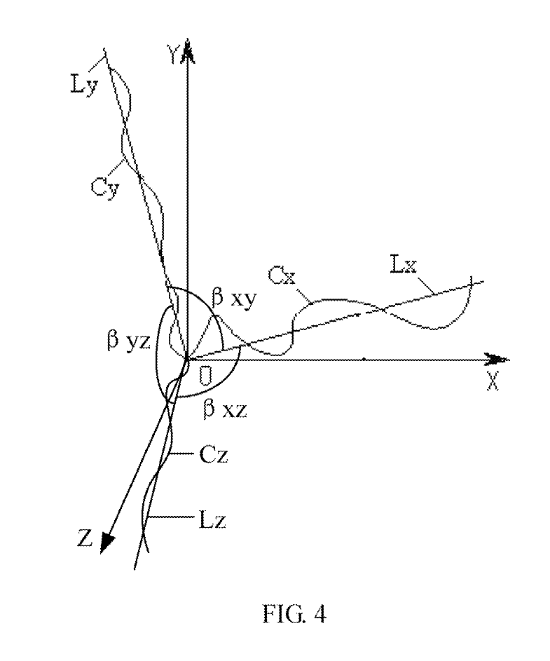

The formulas of computing the angle βxz and the angle βyz are similar. The lines Lx, Ly, and Lz and the angles βxy, βxz, and βyz are illustrated in FIG. 4. In FIG. 4, Cx, Cy, and Cz are curved lines respectively consisting of the coordinates in the X array, the coordinates in the Y array, and the coordinates in the Z array.

The computation module 102 then computes the perpendicular error Axy of the X-axis 20 and the Y-axis 21 according to the angle βxy, the perpendicular error Axz of the X-axis 20 and the Z-axis 22 according to the angle βxz, and the perpendicular error Ayz of the Y-axis 21 and the Z-axis 22 according to the angle βyz. In one embodiment, Axy=90−βxy, Axz=90−βxz, and Ayz_{z}=90−βyz.

In step S04, the perpendicular errors Axy, Axz and Ayz are stored into a compensation record in the storage unit 11 and may be outputted by the display unit 13.

In step S05, the compensation module 103 compensates for measurement results generated by the measuring machine 2 when measuring a three-dimensional object using the compensation record. The compensation record may be applied at the time

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A method for compensating for perpendicular errors of a three-coordinate measuring machine being performed by execution of computerized codes by a processor of an computing device, the method comprising:
(a) acquiring coordinates of points which are on an X-axis, a Y-axis, and a Z-axis of the three-coordinate measuring machine;
(b) recording the coordinates of the points on the X-axis, the Y-axis, and the Z-axis respectively into an X array, a Y array, and a Z array;
(c) computing a perpendicular error Axy of the X-axis and the Y-axis, a perpendicular error Axz of the X-axis and the Z-axis, and a perpendicular error Ayz of the Y-axis and the Z-axis respectively according to the coordinates of the points recorded in the X array, the Y array, and the Z array; and
(d) storing the perpendicular errors Axy, Axz and Ayz into a compensation record.

2. The method according to claim 1, wherein the points are generated by controlling a data acquiring device to move along the X-axis, the Y-axis, and the Z-axis of the three-coordinate measuring machine in turn, to enable the probe of the data acquiring device to touch the X-axis, the Y-axis, and the Z-axis at a predetermined distance during the movement of the data acquiring device.

3. The method according to claim 2, wherein the movement of the data acquiring device approaches a straight line movement.

4. The method according to claim 1, wherein step (c) comprises:
computing a mean coordinates ( X̅₁, Y̅₁, Z̅₁) of the coordinates in the X array, a mean coordinates ( X̅₂, Y̅₂, Z̅₂) of coordinates in the Y array, and a mean coordinates ( X̅₃, Y̅₃, Z̅₃) of the coordinates in the Z array;
constructing a line Lx using the an origin (0, 0, 0) and a first point which has the coordinates ( X̅₁, Y̅₁, Z̅₁), a line Ly using the origin (0, 0, 0) and a second point which has the coordinates ( X̅₂, Y̅₂, Z̅₂), and a line Lz using the origin (0, 0, 0) and a third point which has the coordinates ( X̅₃, Y̅₃, Z̅₃);
computing an angle βxy between the line Lx and the line Ly, an angle βxz between the line Lx and the line Lz, and an angle βyz between the line Ly and the line Lz; and
computing the perpendicular error Axy of the X-axis and the Y-axis according to the angle βxy, the perpendicular error Axz of the X-axis and the Z-axis according to the angle βxz, and the perpendicular error Ayz of the Y-axis and the Z-axis according to the angle βyz.

5. The method according to claim 4, wherein Axy=90−βxy, Axz=90−βxz, and Ayz=90−βyz.

6. The method according to claim 1, after step (d) further comprising:
compensating for measurement results generated by the three-coordinate measuring machine when measuring a three-dimensional object using the compensation record.

7. A computing device, comprising:
a non-transitory storage medium;
at least one processing unit; and
one or more modules that are stored in the non-transitory storage medium; and are executed by the at least one processing unit, the one or more modules comprising instructions to:
(a) acquire coordinates of points which are on an X-axis, a Y-axis, and a Z-axis of the three-coordinate measuring machine;
(b) record the coordinates of the points on the X-axis, the Y-axis, and the Z-axis respectively into an X array, a Y array, and a Z array;
(c) compute a perpendicular error Axy of the X-axis and the Y-axis, a perpendicular error Axz of the X-axis and the Z-axis, and a perpendicular error Ayz of the Y-axis and the Z-axis respectively according to the coordinates of the points recorded in the X array, the Y array, and the Z array; and
(d) store the perpendicular errors Axy, Axz and Ayz into a compensation record.

8. The computing device according to claim 7, wherein the points are generated by controlling a data acquiring device to move along the X-axis, the Y-axis, and the Z-axis of the three-coordinate measuring machine in turn, to enable a probe of the data acquiring device to touch the X-axis, the Y-axis, and the Z-axis at a predetermined distance during the movement of the data acquiring device.

9. The computing device according to claim 8, wherein the movement of the data acquiring device approaches a straight line movement.

10. The computing device according to claim 7, wherein step (c) comprises:
computing a mean coordinates ( X̅₁, Y̅₁, Z̅₁) of the coordinates in the X array, a mean coordinates ( X̅₂, Y̅₂, Z̅₂) of coordinates in the Y array, and a mean coordinates ( X̅₃, Y̅₃, Z̅₃) of the coordinates in the Z array;
constructing a line Lx using the an origin (0, 0, 0) and a first point which has the coordinates ( X̅₁, Y̅₁, Z̅₁), a line Ly using the origin (0, 0, 0) and a second point which has the coordinates ( X̅₂, Y̅₂, Z̅₂), and a line Lz using the origin (0, 0, 0) and a third point which has the coordinates ( X̅₃, Y̅₃, Z̅₃);
computing an angle βxy between the line Lx and the line Ly, an angle βxz between the line Lx and the line Lz, and an angle βyz between the line Ly and the line Lz; and
computing the perpendicular error Axy of the X-axis and the Y-axis according to the angle βxy, the perpendicular error Axz of the X-axis and the Z-axis according to the angle βxz, and the perpendicular error Ayz of the Y-axis and the Z-axis according to the angle βyz.

11. The computing device according to claim 10, wherein Axy=90−βxy, Axz=90−βxz, and Ayz=90−βxz.

12. The computing device according to claim 7, after step (d) the one or more modules comprising instructions to:
compensate for measurement results generated by the three-coordinate measuring machine when measuring a three-dimensional object using the compensation record.

13. A non-transitory storage medium having stored thereon instructions that, when executed by a processor of an computing device, causes the processor to perform a method for compensating for perpendicular errors of a three-coordinate measuring machine, wherein the method comprises:
(a) acquiring coordinates of points which are on an X-axis, a Y-axis, and a Z-axis of the three-coordinate measuring machine;
(b) recording the coordinates of the points on the X-axis, the Y-axis, and the Z-axis respectively into an X array, a Y array, and a Z array;
(c) computing a perpendicular error Axy of the X-axis and the Y-axis, a perpendicular error Axz of the X-axis and the Z-axis, and a perpendicular error Ayz of the Y-axis and the Z-axis respectively according to the coordinates of the points recorded in the X array, the Y array, and the Z array; and
(d) storing the perpendicular errors Axy, Axz and Ayz into a compensation record.

14. The storage medium according to claim 13, wherein the points are generated by controlling a data acquiring device to move along the X-axis, the Y-axis, and the Z-axis of the three-coordinate measuring machine in turn, to enable the probe of the data acquiring device to touch the X-axis, the Y-axis, and the Z-axis at a predetermined distance during the movement of the data acquiring device.

15. The storage medium according to claim 14, wherein the movement of the data acquiring device approaches a straight line movement.

16. The storage medium according to claim 13, wherein step (c) comprises:
computing a mean coordinates ( X̅₁, Y̅₁, Z̅₁) of the coordinates in the X array, a mean coordinates ( X̅₂, Y̅₂, Z̅₂) of coordinates in the Y array, and a mean coordinates ( X̅₃, Y̅₃, Z̅₃) of the coordinates in the Z array;
constructing a line Lx using the an origin (0, 0, 0) and a first point which has the coordinates ( X̅₁, Y̅₁, Z̅₁), a line Ly using the origin (0, 0, 0) and a second point which has the coordinates ( X̅₂, Y̅₂, Z̅₂), and a line Lz using the origin (0, 0, 0) and a third point which has the coordinates ( X̅₃, Y̅₃, Z̅₃);
computing an angle βxy between the line Lx and the line Ly, an angle βxz between the line Lx and the line Lz, and an angle βyz between the line Ly and the line Lz; and
computing the perpendicular error Axy of the X-axis and the Y-axis according to the angle βxy, the perpendicular error Axz of the X-axis and the Z-axis according to the angle βxz, and the perpendicular error Ayz of the Y-axis and the Z-axis according to the angle βyz.

17. The storage medium according to claim 16, wherein Axy=90−βxy, Axz=90−βxz, and Ayz=90−βyz.

18. The storage medium according to claim 13, wherein after step (d) the method further comprises:
compensating for measurement results generated by the three-coordinate measuring machine when measuring a three-dimensional object using the compensation record.
